(19) United States
(12) Patent Application Publication
(10) Pub. No.: US 2015/0050997 A1
(43) Pub. Date: Feb. 19, 2015

(54) 2.5-DIMENSIONAL GRAPHICAL OBJECT SOCIAL NETWORK

(71) Applicants: Ted Suzman, San Francisco, CA (US); Mark Kantor, San Francisco, CA (US); Tim Suzman, San Francisco, CA (US)

(72) Inventors: Ted Suzman, San Francisco, CA (US); Mark Kantor, San Francisco, CA (US); Tim Suzman, San Francisco, CA (US)

(73) Assignee: GRAFFITI LABS, INC., San Francisco, CA (US)

(21) Appl. No.: 14/239,367

(22) PCT Filed: Aug. 19, 2011
(86) PCT No.: PCT/US2011/048466

§ 371 Date: Aug. 26, 2014

(51) Int. Cl. A63F 13/55; A63F 13/822; G06F 3/0484

(52) U.S. Cl. CPC A63F 13/55; G06F 3/04845; G06F 3/04842; A63F 13/822
USPC 463/31

(57) ABSTRACT

An online multiplayer game may have 2.5D user-drawn objects as a central commodity. Users may build compound objects and present them for review by other users, and can receive rewards based on the reviews. A limited amount of energy may be required for object crafting activities, and the energy may be replenished gradually over time. Other resources may be required as well. Players may gain experience points for crafting different classes of objects, and certain classes of objects may require a predetermined experience level to attempt.

### BACKGROUND

With the continued proliferation of social media and online casual video games, it is clear that there has, and will always be, a strong demand for online multimedia experiences that allow users to connect with one another.

### SUMMARY OF THE DISCLOSURE

In some embodiments, a game method may include providing, by a computing device, drawing tools to allow a player to draw a two-dimensional object using line strokes on a drawing interface; displaying a bounding volume on the interface, the bounding volume having an orthographic appearance and being adjustable in three orthographic dimensions; receiving user input to adjust one or more of the orthographic dimensions of the bounding volume to surround the drawn object and customize the bounding volume for the object, and assigning volume dimensions of the bounding volume to the two-dimensional object; generating a display of the object in an orthographic graphical world image maintained by the computing device, and using the object's assigned bounding volume dimensions to detect collisions when placing the object in the orthographic graphical world image; and providing the player with an in-game reward based on usage of the object by other players in the orthographic graphical world maintained by the computing device

In some embodiments, the game method may include storing an object file for each instance of a drawing object, and allowing players to buy and sell instances of the drawing object. The price of the drawing object may be based in part on ratings that the object has received from other players.

Some embodiments may include providing an energy bar amount to the player; and deducting energy from the energy bar as the player crafts an instance of an object from an object plan. Some embodiments may include inhibiting crafting of new instances of objects by a player when the player's energy bar is depleted below a required amount for an object; and periodically replenishing the player's energy bar by a predetermined amount. The game may also provide a limited amount of virtual ink resources to the player; and may deduct amounts of virtual ink from the player's ink resources as the player crafts instances of an object, wherein the amounts of virtual ink deducted is determined based on a number of strokes used by the object creator to draw the object. The game may replenish the player's ink resources in response to the player positioning an onscreen avatar near an ink well in the graphical world and interacting with the well.

Some embodiments may track experience points earned by the player as the player crafts objects; and use the experience points to restrict the player from attempting to craft objects that have a minimum experience point level above the player's experience point level. Multiple classes of experience points may be tracked for the player, each class of experience points corresponding to different classes of drawn objects.

Some embodiments of a game method may include receiving ratings of the object from a plurality of other users, and periodically awarding in-game currency to the player based on a rating level received by the player's drawing creations.

Some embodiments may include a game method of providing, by a computing device, a signal containing a video image having a navigable orthographic map having plots of land; populating the plots of land with aggregate sets of player-drawn orthographic objects; collecting player ratings for the sets of objects; and using the ratings to generate rewards for the creators of the rated sets of objects.

The game method may include generating a drawing interface though which a player is allowed to draw an object using a plurality of line strokes; storing an object plan file for the drawn object; using the object plan file to craft instances of the object; storing an object instance file for the crafted instance; and displaying the instance at a location specified by a player, wherein the object plan file contains a data value indicating how well aggregate sets containing the object's instances have been rated by other players of the game.

The game method may include maintaining a first limited resource level for a player; permitting the player to draw an object without depleting the first resource; and depleting the first resource when crafting an instance of the drawn object; maintaining a second limited resource level for the player, permitting the player to draw the object without depleting either the first resource or the second resource; and depleting both the first and second resources when crafting the instance of the drawn object; automatically replenishing the first resource according to a predetermined schedule; and replenishing the second resource in response to the player navigating a player avatar to a predetermined resource supply object in the orthographic map.

In some embodiments, the game method may include defining a theme for a themed plot in the orthographic map; and increasing ratings on instance set of object instances placed in the themed plot if rating users indicate that the set fits the defined theme.

The method may include generating a drawing interface though which a player is allowed to draw a two-dimensional image using a plurality of line strokes; displaying a resizable bounding volume on the interface, receiving player input to size the bounding volume to surround the drawn image; and using the bounding volume dimensions to position the two-dimensional image using three dimensions in the orthographic map. The reward for the player may include replenishing a limited resource of the player, wherein the limited resource is used in creating instances of drawn objects.

The method may also include adjusting an outer contour of the bounding volume to follow an outer contour of the object.

Some embodiments may include providing, by a computing device, a video image of an orthographic graphical environment, wherein the orthographic graphical environment includes a plurality of object instances; receiving a player request to define a group of the objects as a compound object; generating a compound object plan for the defined group, wherein the compound object plan includes information identifying constituent objects and their positions in the group; and granting the player an in-game reward based on how ratings of the compound object as provided by a plurality of other players in the game.

The compound object plan may further include a history, identifying a sequence of object placement used by the player to position the objects in the orthographic graphical environment; receiving a request from a second player to generate an instance of the compound object by viewing a replay of the compound object plan history.

The list of features above is not exhaustive, and is not intended to limit the scope of this patent. These features, and others, are discussed in greater detail below.

### BRIEF DESCRIPTION OF THE DRAWINGS

Some features herein are illustrated by way of example, and not by way of limitation, in the figures of the accompanying drawings and in which like reference numerals refer to similar elements.

FIG. 1 illustrates an example computing system on which the various features described herein may be implemented.

FIG. 2 illustrates an example display of a virtual orthographic space.

FIGS. 3a-c illustrate an example process for a drawing-based virtual world game.

FIG. 4 illustrates an example plot map of virtual property.

FIGS. 5a-b illustrate example drawing creation screens.

FIG. 6 illustrates example steps in the creation of a drawing object plan.

FIGS. 7-9 illustrate example data files that can be stored to represent an object plan, and object instance, and a player profile, respectively.

FIG. 10 illustrates an example visual interface for an orthographic virtual world.

### DETAILED DESCRIPTION

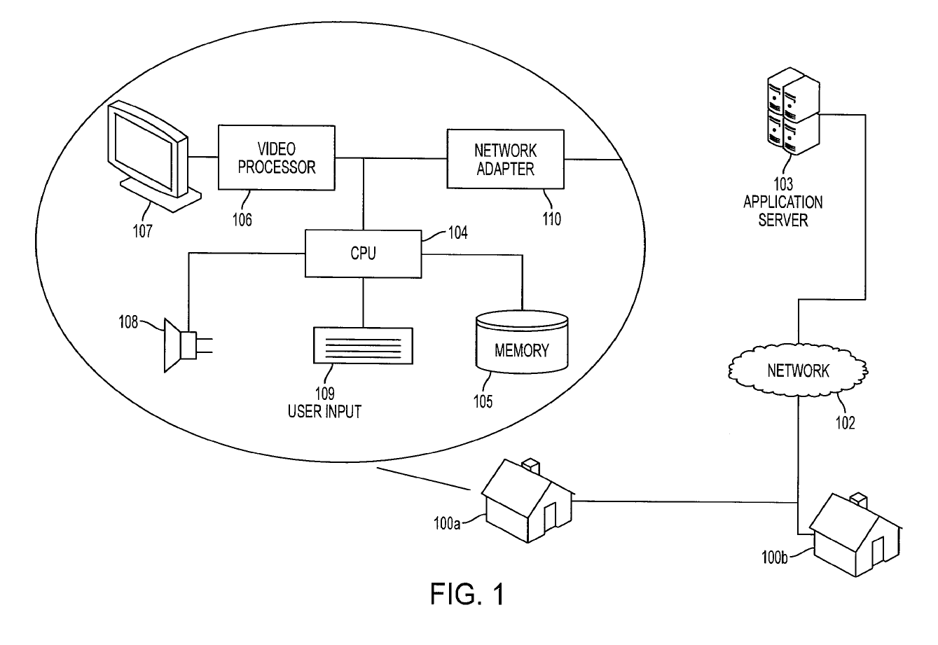

FIG. 1 illustrates an example computing network that can be used to implement any of the various features described herein. In the network, a plurality of users located at different homes 100a-b may be connected to a communication network 102. The network 102 may be any desired type of communication network, such as coaxial cable, hybrid fiber/coax, optical fiber, telephone wire, cellular telephone, satellite, neighborhood wireless, etc. The network 102 may also be connected to one or more application servers 103, which can serve as a centralized server used to offer a variety of services. For example, the application server 103 may host a massively-multiplayer online game.

Devices within the various homes 100a-b may connect to the network 102 and the application server 103 to participate in such a game. These devices can be any desired type of computing device, such as a personal computer, laptop computer, smartphone, tablet computer, cell phone, etc. FIG. 1 illustrates some example components that can be found in such computing devices, using home 100a as an example (although similar devices can be found in various homes and premises). For example, the devices may include a central processing unit (CPU) 104, which can be any desired type of general purpose or dedicated processor. The CPU 104 may operate by reading and executing software instructions stored in a memory 105. The memory 105 may be any desired type of computer-readable storage medium, such as magnetic disk, optical disk, flash memory, etc.

The CPU 104 may use a video processor 103 to render displayable graphics on a display screen 107, and can also generate (with use of an audio processor—not shown—if desired) audible sounds using one or more speakers 108, to provide users with an audiovisual experience. The CPU 104 may include one or more user input devices 109, such as game controllers, joysticks, keyboards, mice, touch-sensitive display screens, microphones, motion-sensing and/or direction-sensing input devices, etc. to receive input commands from the user and to allow the user's audiovisual experience to be interactive.

The computing device may also include a network adapter 110, which can be configured to communicate with the network 102, and ultimately with the application server 103. The adapter 110 can be of any desired type, such as a coaxial cable modem, wireless or cellular transceiver, satellite transceiver, optical modem, etc.

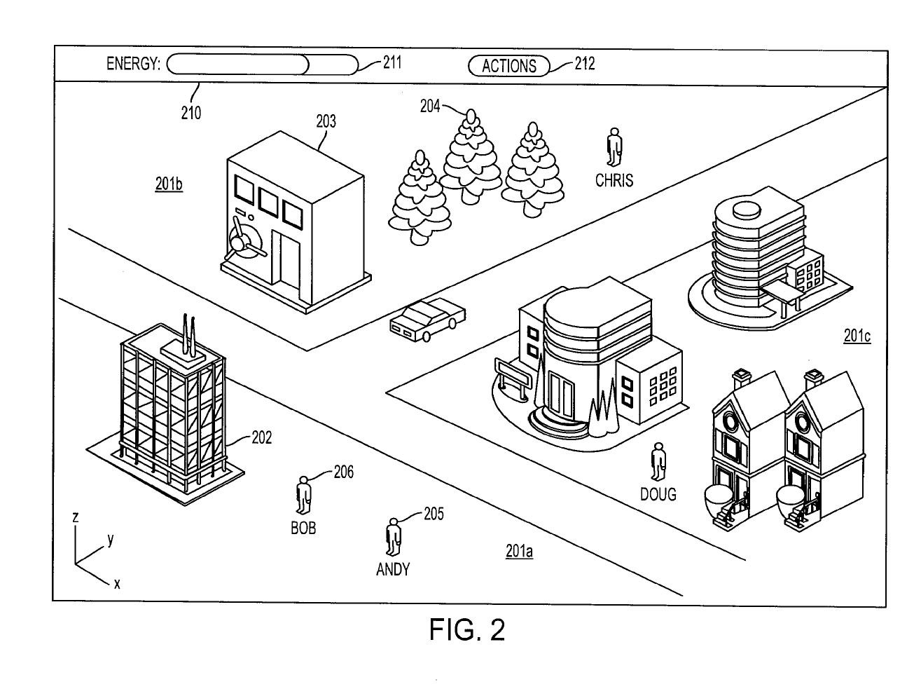

FIG. 2 illustrates an example interface screen for a game embodying various features described herein. In the interface, an orthographic representation of land and objects can be depicted in a plurality of plots of land 201a-c. The orthographic presentation may involve representing a three-dimensional coordinate system and objects using a two-dimensional image, such as that on a computer screen. The view may appear as a perspective view of a solid three-dimensional object, where the three dimensions are observable in the two-dimensional view. Any type of orthographic representation may be used, such as axonometric projections, isometric, diametric, trimetric, etc. Such an orthographic system may be referred to as a “2.5-dimensional” representation. Each plot of land may have one or more objects placed thereon. For example, plot 201a is shown with a single building 202 located on it. Plot 201b has a building 203 and three trees 204, while plot 201c has three buildings. In some embodiments, each of these objects can be a graphical object that was drawn and created by a player of the game.

The players of the game may be represented by onscreen avatars. For example, FIG. 2 illustrates a player whose avatar 205 “Andy” is shown standing on plot 201a. That avatar may correspond to a first player of the game, and that player may use a controller to enter commands to move the player's avatar 205 to different locations in the plot 201a. For example, a player can use a mouse to click on areas of the displayed screen, and the CPU may cause the avatar 205 to animate and move to the clicked location.

The first player's computing device may be connected online to the application server 103, and as a result the avatars of other players may also move into the displayed space on the first player's screen. For example, FIG. 2 illustrates the avatar 206 for a second player (“Bob”) also standing on plot 201a, besides Andy. The Bob avatar 206 may be under the control of a different player in a different location (e.g., a player in home 100b), and may move based on inputs received from that different player.

Avatars for other users (e.g., “Chris” and “Doug”) are also depicted, and during play of the game, the various players may each control their avatars to move around and visit different plots of land.

The interface may also include other elements, such as a command bar 210. The command bar 210 may include one or more selectable menu options, and can provide interactive options to the player. For example, the bar may include an energy bar 211. The energy bar 211 may represent an amount of energy that the player currently possesses. A player's avatar may consume energy when taking certain action, and the consumed energy depletes the player's energy bar 211. Over time, a player's energy bar 211 may gradually refill. So, for example, the energy bar 211 may depreciate by 20% (or any desired unit of measure) in order to create a virtual object (e.g., building 202, tree, 204, or any other desired virtual object in the game). The bar 211 may also regenerate by 1% (again, any desired unit of measure can be used) every minute of in-game play (e.g. time passed while the player is playing the game). In some embodiments, the energy bar 211 may regenerate even when the player is not playing the game (such regeneration can be determined by the player's computing device CPU or by the application server 103 when the player resumes play, by comparing the current time and date with the last time and date when the player played the game).

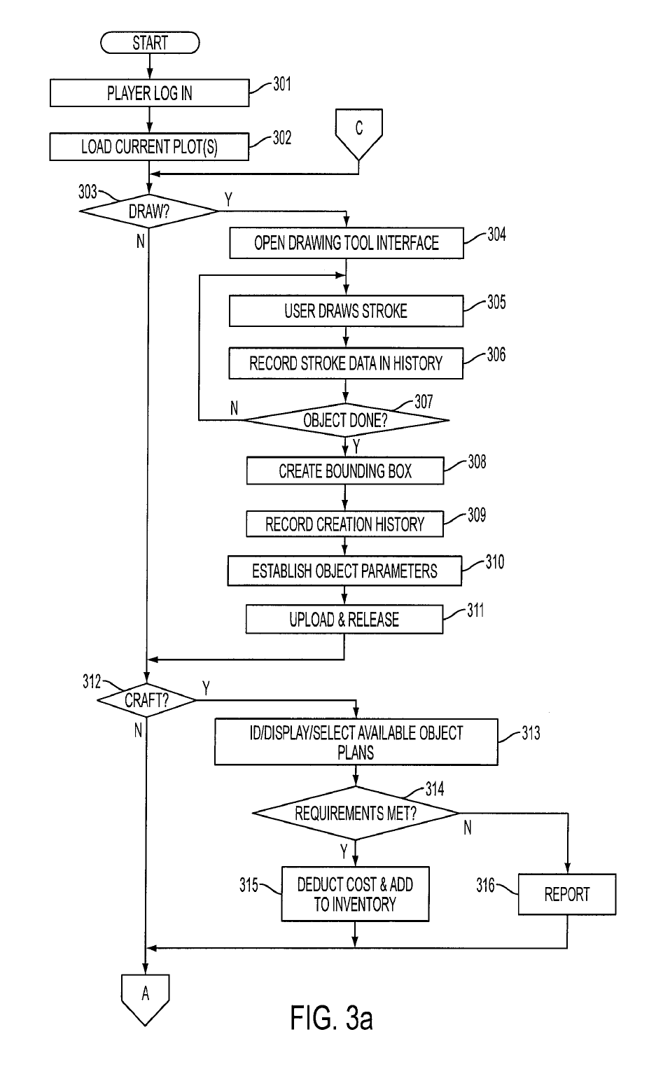

The command bar 210 can also include one or more selectable action icons 212, which when selected, can cause the computing device to perform different functions, such as signing out of the game, creating a new virtual object, or any of the other options and actions described herein. Examples of the various actions will be discussed below, in connection with FIGS. 3a-c.

FIGS. 3a-c illustrate an example process that can be performed by the player's computing device, the application server 103, or a mixture of the two, to provide the player with the interactive gaming experience described herein. In step 301, the player may begin by logging in to the application server 103. This may entail, for example, supplying a user name and password to the application server 103.

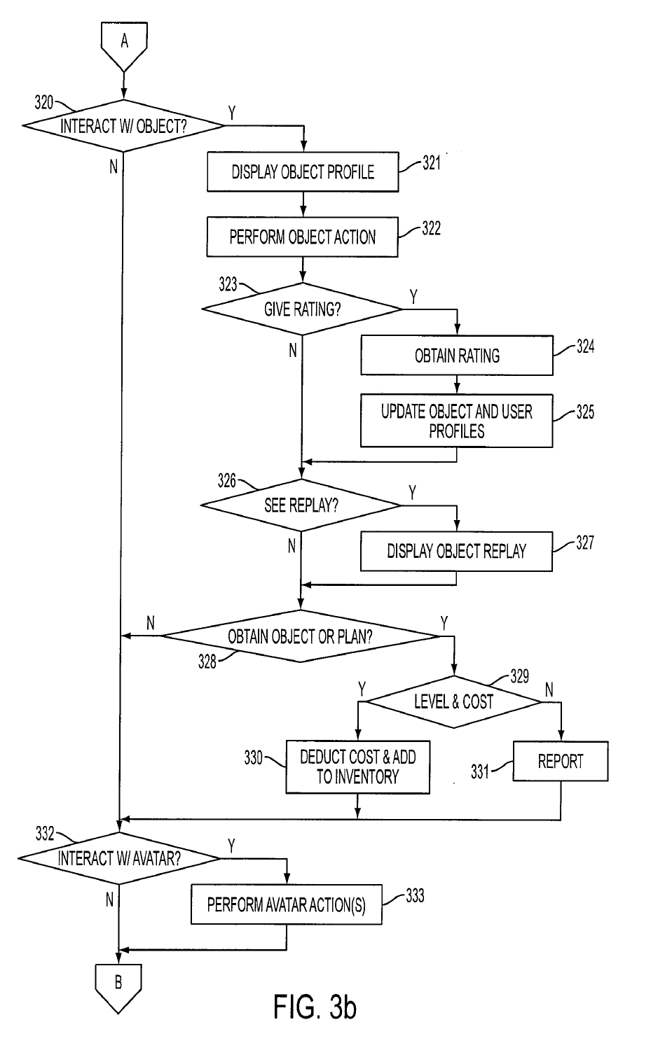

Assuming that the player has entered a valid user name and password (as determined, for example, by the application server 103), the player's computer can proceed to step 302, and load the current plot or plots that are to be visible to the player. The current plots may be determined based on the player's avatar's final position the last time the player played the game. For example, when a player decides to quit the game, the application server 103 may determine where in the virtual world the player's avatar was standing at the time. To this end, the application server 103 may store a database identifying the universe of virtual land, the location of plots of land, and the locations of every virtual item in the virtual world. FIG. 4 illustrates an example overhead map depicting the available universe of virtual land, and the various plots that are assigned to different players. Of course, this is merely an example, and in implementation the map can be divided in any desired manner, and can be of any desired size.

In some embodiments, the player may always begin a play session at a predetermined location, such as standing on an original plot of virtual land that is owned by or assigned to the player. In this manner, if the player were to wander far away from the player's virtual home in a given play session, the player can rest assured knowing that the next time the player logs in, the player's avatar will be returned to its known home starting position. In some embodiments, players may be given the option to determine where they will reappear the next time they log in to play the game.

The determination of the plots to display can also be based on a zoom factor. In some embodiments, the application server 103 may allow the player to specify a zoom factor (e.g., zoom 1× to 10×), and the larger the zoom, the larger things will appear on the screen, and consequently, the smaller amount of virtual land will fit on the display screen.

After the initial location and plots have been determined, the application server 103 can download graphics files to the player's computing device to generate the display (e.g., FIG. 2) on the user's computing device display screen. In some embodiments, the displayed screen can be generated by the application server 103, and delivered to the user's computing device for simple display. Doing so may allow the user to use a less-sophisticated computing device to play the game.

In step 303, the game (either the application server 103 or the player's computing device, although the player's computing device is used as an example in the remainder of the discussion below) can determine whether the user has requested to draw a new object. The player may do this, for example, by selecting a drawing action 212 or entering a creation command using the input device 109.

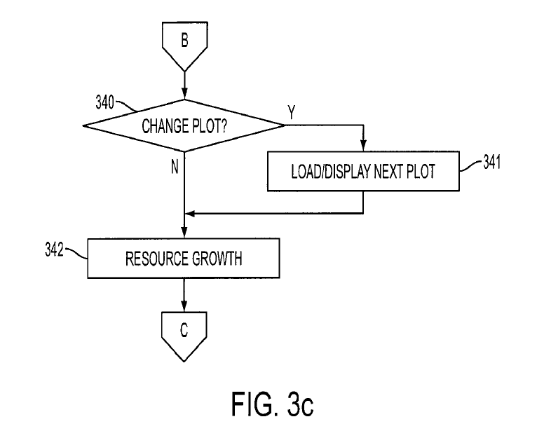

If the user has requested to draw an object, then the player's computing device can proceed to step 304, and open a drawing tool interface to allow the player to create a drawing and its associated object plan. FIGS. 5a-b illustrate an example drawing interface 500, which may be opened as a separate web browser window from the main world display. The interface 500 can include a space 501 in which the user may use an input device (e.g., mouse pointer, touch screen stylus or finger, etc.) to dynamically draw an object using a plurality of line strokes. For example, the user can move a mouse pointer across space 501 and, by pressing a mouse button, can place a virtual pen “down” on the space 501 to draw lines by dragging the mouse across the area 501. Alternatively, the user can use a finger on a touch-sensitive display, a stylus, or any other desired drawing input device. The space 501 may include an orthographic or 2.5-dimensional background grid, to assist the player in forming the drawing. The drawing is created in 2D. When the user is finished drawing, the user can create a bounding volume 504 around the perimeter of the drawing to encompass it, and to give the 2D drawing a 3D volume that can be represented in the orthographic view. To do so, the player may use a command bar 503, which can include command options for various drawing features. The command bar 503 can include various options (not all shown) for setting drawing characteristics, such as line type (freeform, straight, spline), shapes (circle, square, etc.), line color, line finishing (e.g. arrowheads, dashed), line weight (thickness), paintbrush appearance, etc. Other commands include text editing, view rotation, layer creation, orthographic crafting tools (e.g., cursor becomes an orthographic paint brush or carving tool). When the bounding volume 504 is added, and after the user adjusts the three dimensions of the volume to surround the object, the computing device can then assign the dimension values of the volume to the 2D drawing.

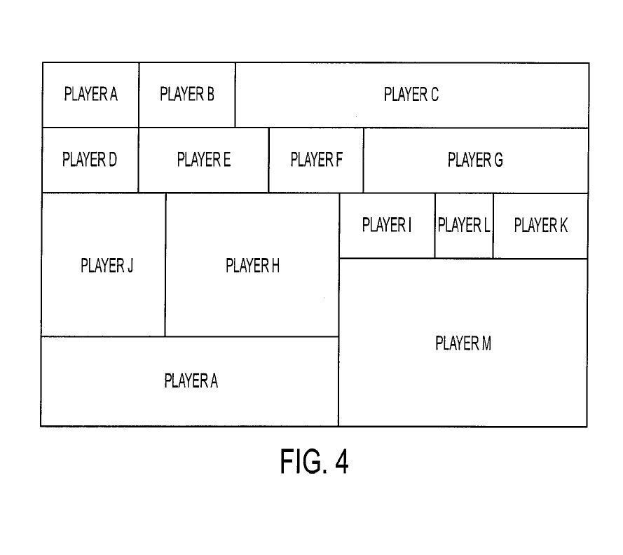

FIG. 6 illustrates an example sequence of steps for the drawing creation above. In step (i), the user may have first drawn a single circular stroke. In step (ii), the user may have added six nearly-circular strokes to form the petals of a sunflower. Steps (iii)-(v) may involve the addition of several more strokes to add the sunflower's stalk, petals, and face. When the user enters a command indicating he/she is finished, the computing device can display the bounding box 504, and as shown in step (vi), the user can resize the bounding box to surround the sunflower and to define the 3-D volume space that the user envisions the sunflower as having. By creating the bounding box, the user gives the 2D drawing a 3D volume, and informs the computing device how to account for the item in the orthographic view for purposes of collision detection and depth sorting/surface hiding. For example, when using the orthographic view to represent the three dimensions of objects, the computing device generating the display can determine whether a proposed placement location for an object would result in the object colliding with a neighboring object (e.g., if the bounding volumes for the two objects overlap or encompass a common coordinate point in the virtual world image). Referring back to the FIG. 5 illustration, the bounding box 504 may include handles 505 that the user can drag to define the bounding box's shape. In some embodiments, the user may draw multiple bounding boxes around different portions of the object, and each bounding box defines a volume for a portion of the object.

Drawing an object can involve the user virtually drawing on the area 501 using a virtual brush. In some embodiments, the user can create multiple sequential versions of the object, to generate an animated object. The user can also use pre-existing objects to assemble an object, or to add to an object.

Returning to FIG. 3, in step 304 the computing device may open the drawing interface, and the user can begin drawing. In step 305, the user may add a stroke to the drawing, and in step 306, the computing device may record that stroke data in a memory history file. The stroke data may be vector image data identifying starting/ending positions of the stroke, the stroke path coordinates, ink color, line thickness or type, or any other desired stroke characteristic.

In step 307, the computing device may determine whether the player has indicated that he/she is finished with the drawing. The player may indicate this by entering a “Done” command or selecting a corresponding menu option. If the player is not yet finished, the computing device can return to step 305, repeating the drawing until the player is finished. Although the flow diagram only illustrates these drawing steps, other functions, such as an “Undo” function to remove the last drawn stroke, or an “Abort” function to cancel the drawing before beginning, may also be provided.

If the user is finished drawing, then in step 308 the computing device may generate a bounding box, and may prompt the player to resize and adjust the bounding box so that the box surrounds the 2D drawing that the player drew. Creating the bounding box gives 3D volume to the user's 2D drawing. Although a box is discussed, it is merely an example, and any volume shape can be used (cylinder, sphere, etc.). The volume can also be customized to follow an outer contour of the drawing.

In step 309, the creation history of the object can be stored to a file associated with the object's plan. This history may, as noted above, include vector image information identifying positions and characteristics of individual strokes made by the user when drawing. The history may also include a time stamp for each stroke, indicating a time when the stroke was made. The time stamps may be helpful for determining how complex a particular drawing was to make.

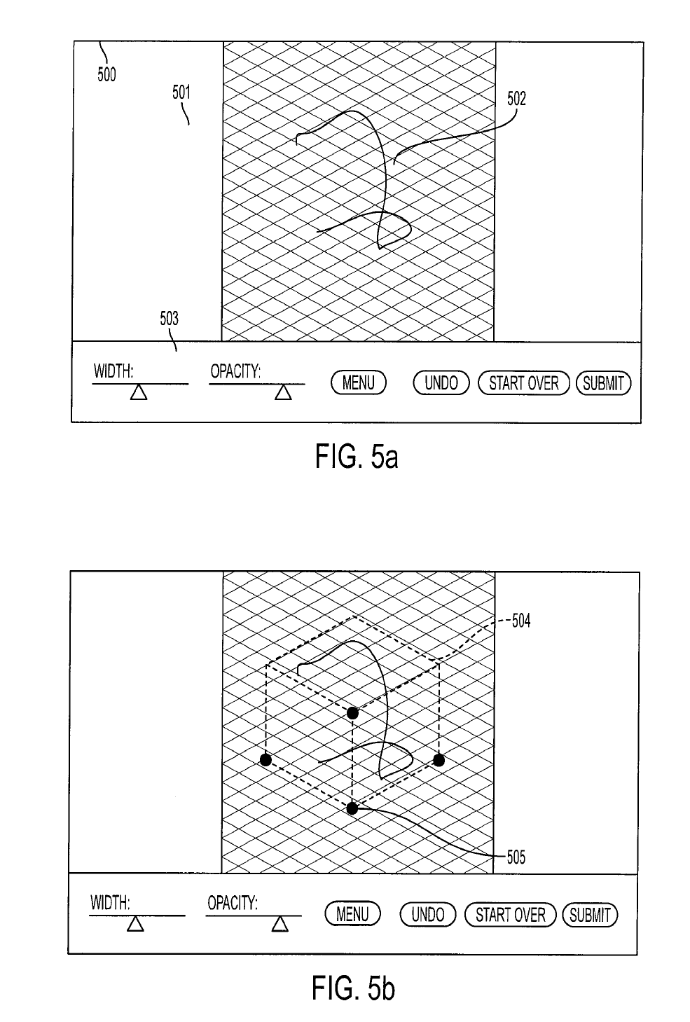

In step 310, the computing device may generate an object plan data file 700 for the newly created object, and establish various parameters for the created object plan. An object plan, in general terms, may contain information regarding the original creation of a drawing object. The object plan may be a data file containing a variety of data values for the object, and FIG. 7 illustrates an example data structure for such a plan. For example, the object plan 700 may contain an object plan name 701 field identifying a name of the object plan that the creator provides upon creation.

The object plan can include information identifying the object's original creator 702. This can be, for example, a name (e.g., “Andy”) used by the player in the game's virtual world. Alternatively, the name can be any desired identification of the author, such as an email address, an actual first and/or last name, a device address, an account number, or any other desired identifier.

The plan for an object may also contain an identification of the object's owner 703. As noted above, multiple instances of a single object can exist in the game's virtual world. Each such instance may have a profile associated with it, and the instances can be owned by different players of the game. The instances may be bought, sold, traded, or otherwise distributed to players, and each player may own an instance of the object, and may be identified as the owner in that instance's profile.

The plan may also contain information identifying the date of creation 704, and an identifier of a file name and/or location for the history of its creation 705 (stored in step 311).

The object plan may also contain an identifier 706 of the various object(s) and/or components that comprise the object. For example, if an object plan was created using 437 brush strokes, then the component data field may indicate that fact. If an object plan was a compound object plan created using 12 cubes and 300 instances of an object named “Brick0001”, then that fact may be identified in the component data field as well. This components list, akin to a parts list, can help other players understand what assets they may need to assemble a version of the object for themselves. For compound object plans, the listing of components can also include a listing of the relative positions of the components, relative to an origin point for the compound object.

The plan may also contain a classification identifier 707. The classification identifier can identify one or more classifications or characteristics of the object. For example, one type of classification may be the size of the object's footprint in the virtual world, measured in square units (e.g. virtual square feet). For such a footprint classification, the classification identifier 707 may indicate the total number of square units (e.g., 240 sq. units), or dimensions (e.g., 34×10 units) of the object or its bounding box (the bounding box can approximate the shape or volume to a standard unit type, such as cubes, rectangles, spheres, circles, cylinders, etc.).

Multiple classifiers are possible. For example, another type of classification may be based on real world counterparts. Real word objects such as buildings, ground cover, wall hangings, walls, vehicles, furniture, etc. can each be a class of object identified by identifier 707. So if the object is a lamp, then its classifier 707 may indicate that it is in the “furniture” class. Other kinds of classes can refer to material types that the artist was attempting to replicate with the drawing. For example, objects can be classified as “granite,” “wood”. “wool cloth”, etc. to indicate that the drawn object was intended to resemble those materials. The different classifications of objects may be used, as described later, to provide different areas of expertise to different players.

The object plan may also include one or more interaction function identifiers 708. These interaction function identifiers may identify one or more procedures, process calls, system commands, uniform resource locators (URL), or other functions or commands that are to be executed or accessed in response to a player choosing to interact with the object. For example, one object may indicate that upon selection for interaction, a particular animation of the object should be played.

The object plan can also include a rating field 709, indicating how well this object (or instances of it) has been received. As noted below, players of the game may wander through plots of land, observe the various user creations, and give them ratings reflecting how much they enjoyed the objects. These ratings may be collected and stored in the ratings field 709 of the object's plan, which can be a single value reflecting an average of ratings that the object has received, or it can be a more detailed listing of each rating (e.g., identifying the players who gave the ratings, how many ratings were received, etc.). In some embodiments, the ratings may include textual comments entered by the rating player.

The object plan can also include one or more requirements 710 for crafting an instance. The requirements 710 can indicate what is required of a player who wishes to acquire the object from the current owner, or who wishes to create or craft an instance of the object, or to acquire the object plans for the object. In some embodiments, individual instances of objects can be bought, sold and traded, but the owner of an instance cannot freely make copies of it. Instead, the ability to craft instances of the object may be limited to players who own the plans for that object. So the original creator of a sunflower may be able to use the plan to craft multiple sunflowers, but the players who buy those sunflowers may only be permitted to use and dispose (e.g., sell or trade) of their sunflower instance(s), and they may be prohibited from creating copies of the sunflowers.

The requirements can be a cost in in-game currency. The requirements can also include a level or experience requirement. For example, crafting or creating an instance of an object may require that the prospective buying player have a certain minimum number of experience points. Different requirements can be established for different types of acquisition. For example, buying the owner's copy of the object can have one requirement, while crafting a duplicate instance of the object from the current owner can have a different requirement. Obtaining the object plan can have yet a different requirement. In some embodiments, the cost requirements can vary depending on the rating level of the object. For example, an object receiving positive ratings above a predetermined threshold (e.g., 80 positive ratings) can have its price increased by a set amount (e.g., 10% of cost to make, 1 coin, etc.), and further increases can be made as more ratings are received.

In some embodiments, the plan can also include restriction values 711, indicating what the current owner is allowed to do with the object. For example, the original creator may restrict the owner from making changes to the object, or from selling the object, its copies or its plan.

The plan may also include the graphic data 712 for the object. The graphic data may be the vectors, bitmaps, or other pieces of data that are used by the computer to generate the display of the object. This data may be the same vector image data stored in the history 705 and/or 309.

The plan data may include a two-dimensional height and width 713 of the drawing, as it appeared in the drawing window 501 when the creator drew it. The plan data may also include three-dimensional height/width/depth dimensions 714 of the bounding box (or boxes).

The plan data may include origin offset information 715, indicating a two- or three-dimensional offset (e.g., height, width, depth) between an origin point of the 2-D drawing and an origin point of the 3-D bounding box. The origin offset information may be useful in accurately placing instances of the object in the orthographic view of the virtual world display image.

The plan data may include a scale factor 717, which can be a value used to scale object instances up or down to match the scale of the virtual world's orthographic view. For example, a scale factor of 2.0 may result in rendering the object instance's dimensions at a 2-to-1 ratio as compared to the scale in the virtual world (e.g., a drawing two units high in the plan may be drawn as 4 units high in the virtual world rendering).

The plan data can also include a snap value 718, which can indicate whether instances of the object should snap to match an orthographic grid in the virtual world display. Snapping to a grid may help the player with more orderly placement of the object instances.

When all of the parameters have been established, the computing device may upload 311 the object plan's data files to the application server 103, and can make the object plan available for viewing in the virtual world. For example, and as will be explained below, the creator may use the object plan to craft multiple copies or instances of the sunflower for placement in the virtual world.

In step 312, the computing device may determine whether the player has requested to craft an instance of an object. The drawing of the object discussed above resulted in the creation of an object plan, but it did not result in any actual sunflowers being placed in the virtual world (although in some embodiments, an instance of the object may automatically be generated for the creator after making the object plan). Creating sunflowers for placement in the virtual world may be accomplished through crafting. If the player has elected to craft an object (e.g., by selecting a crafting menu item, then in step 313, the computing device may first determine what object plans are available to the requesting player. An object plan may be available to the player if the plan is in the player's inventory of possessions (discussed further below). Other plans may be available based on the player's avatar's location in the virtual world. For example, a set of plans may be associated with plot 201a, and if the player requests to craft an object while his/her avatar is positioned on plot 201a, the associated set of plans may be offered for the player's selection. Still other plans may be universally available, such that the plans may be available to all players, regardless of whether the players own the plans and regardless of where the players' avatars are positioned. Step 313 may also include the player selecting one of the available object plans.

In step 314, the computing device can determine whether the player has the necessary requirements for crafting the selected object. As noted above, certain actions in the game may require an amount of energy. The plan may indicate that adding the object will require 50 units of energy, and in step 306, the computing device can check to determine whether the player has sufficient energy.

Other resources may be required as well. For example, some objects may require a predetermined amount of virtual ink for the crafting, where players are allocated a limited amount of virtual ink. Some objects may require a predetermined amount of in-game currency for the crafting, and other resources may be required as well. The different resources may be replenished in different ways, such as the passage of time for energy, the collection of ink from ink wells, and the acquisition of currency through receiving popular ratings or selling of crafted objects. Additional details of these resources are discussed further below.

Another requirement may be experience level. As the player progresses through the game and completes more actions, the player may gain experience points based on the completed tasks. For example, drawing a new hand-drawn object may grant the player 5 experience points. Assembling a conglomeration of objects may be worth 7 experience points. The game software may define a variety of tasks with their corresponding experience point values, and during game play, the player's computing device can monitor the player's actions to determine whether a task has been completed by the player, and can award the player points as a result of completion. The points that a player accumulates may be totaled by the application server 103, and may be stored in a memory there to reflect the player's experience level in the game. Crafting an object may require a minimum experience level. The plan file may indicate this required level (e.g., indicating that a player must have 1,000 experience points before the player is permitted to assemble a particular conglomeration).

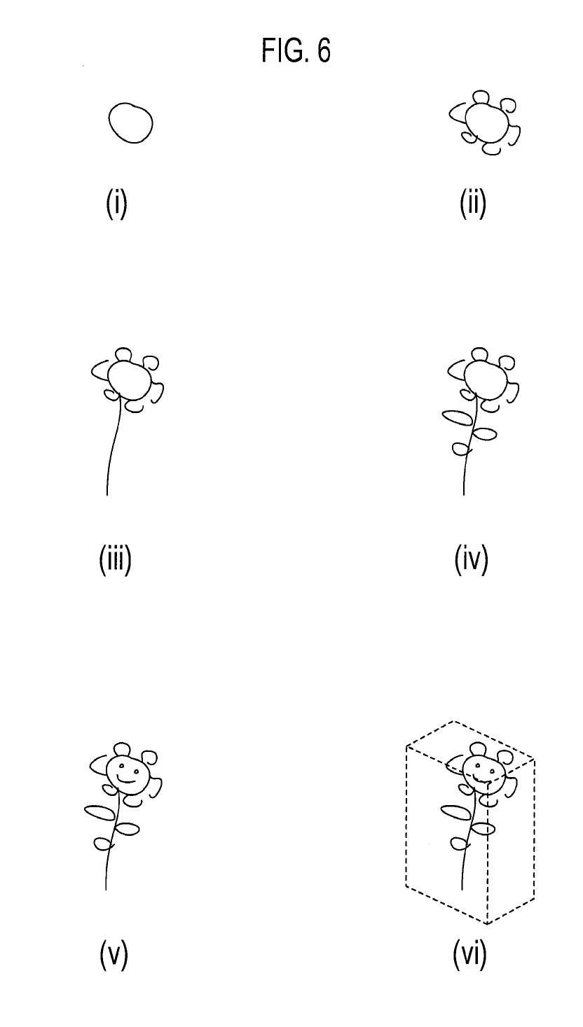

If the requesting player meets the requirements, then in step 315, the computing device may process the transaction, and deduct the cost from the requesting player's resources, and add the object instance to the player's inventory. In some embodiments, the transaction may also require consent of the object's current owner, so that can be another requirement that must be satisfied (e.g., the current owner's consent may be solicited with a pop up or message). Creating the instance of the object may result in creating an instance data file, such as the one illustrated in FIG. 8. As illustrated, the instance data file (which can be stored at the application server 103 or the player's local computing device) may include a plan name 801, identifying the original object plan for the object. This plan name 801 may be the same as the plan name 701.

The object instance data may include a plot identifier 802, identifying a plot of virtual land on which this instance is located.

The object instance data may include an owner name 803 identifying the player who owns this instance of the object.

The object instance data may also include coordinate data 804, indicating the coordinates within the plot (or within the virtual world) where the object instance is currently located. Display parameters 805 may also be included, and may identify additional characteristics of the object, such as its orientation (e.g., it can be rotated from the original view), or whether it is mirrored (e.g., it can be a mirror reflection of the original), or whether it is scaled to a different size from the original. The date of creation 806 may also be included, indicating the date on which the instance of the object was crafted.

If the requesting player fails to meet the requirements, then in step 316, the requesting player may be notified of this fact. For example, the player may receive a message indicating that their level is too low, or that they require more in-game coins.

Proceeding to FIG. 3b, and step 320, the computing device can determine whether the player has chosen to interact with an object instance in the game's virtual world. Object interaction can be initiated, for example, by a user moving his/her avatar to face an object, and pressing an “interaction” button on a computer keyboard or game controller. The objects being interacted with may be a single drawn object, such as the sunflower from FIG. 6, or an aggregate set of objects, such as an entire garden in which multiple instances of the sunflower are arranged on a plot by the plot's owner, or an owner's entire plot of land. An object can be an aggregated set of smaller objects.

If the player has chosen to interact with an object, then the computing device may proceed to step 321, and display the object instance's profile information for the user to see.

In step 322, the computing device can perform one or more actions that are to occur upon interaction with the object. Various interactions can be defined. As noted above, one example interaction is an animation of the object. Another type of action can be the extraction of virtual ink from virtual ink wells. As noted above, a player may possess a limited amount of ink that can be used for crafting objects. Scattered throughout the virtual landscape may be virtual ink well objects that, upon interaction, can provide an amount of ink to an interacting player.

Another type of interaction may involve a player giving a rating to the object. Step 323 illustrates a determination of whether the player has chosen this form of interaction.

If the player has chosen to provide a rating, then in step 324, the player may be prompted to rate the object (which, as noted below, may be a collection of object instances in a compound object). The rating may be a simple five-star rating scale, in which the user may provide a number of stars commensurate with how much the player likes the object (e.g., 3.5 stars, 2 stars, etc.). Any desired rating scale may be used.

The ratings can be more than a single value if desired. For example, different ratings can be given for different categories, such as beauty, complexity, whether the object is funny, etc. The ratings can be given for an object that is an aggregated set of smaller objects (e.g., a garden having many instances of flowers drawn by different players, or a castle built using bricks and doors drawn by different players), and a rating given to the aggregated set can be propagated to each of the constituent objects in that set. Alternatively, a rating given to an aggregated set might only be recorded in the data file for the set, such as the scene plan file described in paragraph 101 below.

In step 325, the rating(s) provided by the player may be transmitted to the application server 103, which may then update the necessary object profiles to reflect the ratings. For example, the newly-added rating can be used to adjust the average rating for the object in the creator's profile for the object. For example, if an original creator creates an object plan and crafts ten instances that are then purchased by ten other users, and players view and rate the instances displayed by those ten other uses, those ratings can be supplied to the original creator's plan for the object, in addition to (or instead of) the profiles for the ten instances. In some embodiments, the ratings information can be passed on to the personal profile of the creator, discussed further below, as well as the object plan. The personal ratings can allow individual players to gain renown for their work being highly rated in general.

In step 326, the computing device may determine whether the user chose to view a replay of the creation of the selected object. If so, then in step 327, the computing device may generate a display showing the step-by-step creation of the object. The replay may be taken from the history file discussed above, and can show each step in the creation of the object plan as it occurred. The replay speed may be adjusted for faster or slower playback. In some embodiments, the replay may pause after the addition of each drawing element (e.g., each stroke of the original creator's brush, or addition of each new object), and can await input by the interacting player to proceed. In some embodiments, this interaction can be an onscreen stroke. So, for example, a user can view the replay and advance the replay by making onscreen strokes to virtually paint and recreate the object. The onscreen strokes need not even match the creator's strokes (although if desired, the replay interface can suggest to the interacting player where the next advancing stroke should be placed).

In step 328, the computing device can determine whether the interacting player has requested to obtain an instance copy of the object, and/or the plan for creating the object. If the player has requested to do so, and if the owner of the object has the right to comply (an owner's right to redistribute the object, or to sell copies or the original plans, may be restricted by the original creator or an intermediate provider), then in step 329, the computing device may determine whether the requesting player has the appropriate requirements for obtaining the object.

As noted above, each player in the game can earn experience points for accomplishing tasks in the game, and in step 329, the computing device can determine whether the requesting player has enough experience points to make the requested acquisition. The computing device can also determine whether the requesting player has sufficient resources for the acquisition. The resource cost may include an in-game currency cost (e.g., virtual coins), an energy cost, or any other desired type of resource.

If the requesting player meets the requirements, then in step 330, the computing device may process the transaction, and deduct the cost from the requesting player's resources, and add the object plan and/or instance to the player's inventory. In some embodiments, the transaction may also require consent of the object's current owner, so that can be another requirement that must be satisfied (e.g., the current owner's consent may be solicited with a pop up or message).

If the requesting player fails to meet the requirements, then in step 331, the requesting player may be notified of this fact. For example, the player may receive a message indicating that their level is too low, or that they require more in-game coins.

In step 332, the computing device may determine whether the player has chosen to interact with another avatar. If so, then in step 333, the computing device may perform the avatar interaction function requested. Such functions may include, for example, sending a message (e.g., “I really like your work”), or asking to be notified of future actions taken by the other avatar's player. For example, a player can choose to become a follower of the other player, and can receive periodic updates about that other player's progress, such as level increases, new drawing creations, etc. As another example, the requesting player may choose to add the other player as a friend, and if accepted, the players can become associated with one another, and can appear in each others' friends lists when, for example, a player's profile is viewed.

Referring to FIG. 3c, in step 340, the computing system can determine whether the player has moved to a different plot, or moved such that a different plot of virtual land needs to be displayed. If this has occurred, then in step 341, the device can retrieve (e.g., from application server 103) data identifying the objects to appear on the next plot, and can render those objects for display as the player moves.

In step 342, the computing device may determine whether any resource growth is suitable for the player. Resource growth can include, for example, timed increases in the player's energy level. For example, the player's energy level may increase by a set percentage every minute. Another example of resource growth can be rewards for receiving positive ratings on creations, which can encourage players to create new and interesting drawings and works. For example, a player may receive a predetermined award (e.g., in-game currency, ink, energy, or any other resource) for each positive rating that is received for one of the player's creations. Rewards may be granted for providing ratings (good or bad) to other players' works, which can encourage exploration and rating interactions.

Some rewards can be based on how frequently or how often a player's plot is visited by other players. For example, a predetermined number of in-game coins may be granted for every 5 visitors that a player's plot receives. The coins can then be used to purchase object plans and/or object instances from other players.

In some embodiments, the rewards can be object instances or plans. For example, a sponsor or user may create an object plan, and register it with the application server 103 such that players who satisfy certain requirements may receive instances of the object. For example, a sports video game company can create an object with a unique gaming logo, and can offer instances of the object to players who draw 20 footballs, or who receive ratings on created objects containing the company's logo or a symbol.

The reward can also be experience points. For example, a player may receive a predetermined number of points in a stoneworking crafting skill for every 10 players who provide a rating on the player's stone castle. The reward in general can be based in part on the classification of the player's objects that are being rated. For example, ratings of a player's flowers can provide increased quantities of green ink, which can be a requirement for crafting objects that are plants. Ratings on a player's plant may increase the player's skill level for drawing plants.

Rewards can also be based on plot themes. For example, a given plot may be designated as having a particular theme, such as a medieval theme. The designation may be indicated in the plot's data structure (e.g., a data structure showing the delineations of FIG. 4). Players may be welcome to place instances of their own creation in the plot, where the instances all relate to a medieval theme. Players can rate the objects based on how well they match the theme, and the creators may receive rewards that can be enhanced for matching the theme. For example, a two-star rating may receive an extra half-star if it matched the requisite theme (as rated by the players).

A reward may be in the form of recognition. For example, the application server 103 may maintain a leaderboard ranking of the most highly-rated objects, sorted by object classification, and the leaderboard can be accessed through the game interface menu. Players may enjoy seeing their creations (and themselves) listed on the leaderboard, and may compete to create the most impressive drawings to garner the highest ratings.

Resource growth can also include acquiring more plots of land. A player may begin the game with a relatively small plot of virtual land on which to display his/her drawing creations. As the user gains experience and/or currency, the user may be granted additional plots of land, or may purchase additional plots using in-game currency. These additional plots of land can then be used to display more creations, which in turn can attract more visitors and ratings.

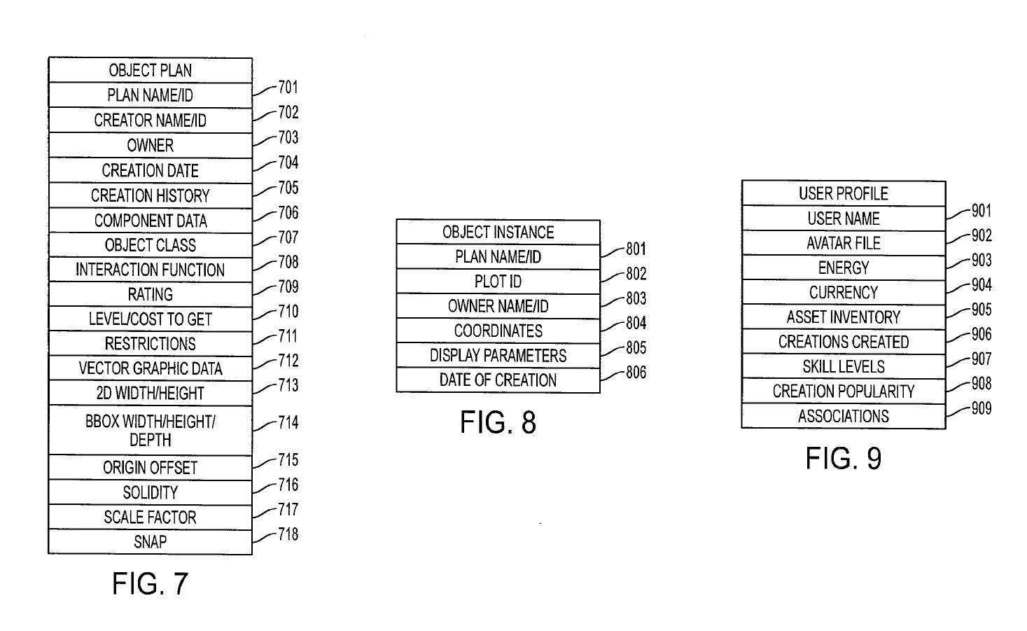

FIG. 7 above illustrates an example object plan that can be stored as a data file for individual plans, and FIG. 8 illustrates an example data file for an object instance. Similarly, data files may be created and stored for players as well. FIG. 9 illustrates example contents of a user profile. The user profile may include a name 901 for the user, and a file for the avatar image 902 that the user wishes to use when represented in the in-game virtual world. The avatar image may be, for example, an animated icon file.

A user's profile may include an energy value 903, representing the player's current level of energy. As noted above, this energy may gradually refill over time at a predetermined rate.

The user profile may include a value indicating an amount of in-game currency 904 that the user possesses. This currency can be used to purchase in-game items, such as objects from other players. As noted above, the currency can be gradually earned as the user's creations are rated, or as the user accomplishes tasks that earn currency.

The user profile may also include an asset inventory 905, which can identify the various additional assets that the player possesses. These assets can include, for example, different amounts of ink in different colors, other drawing tools (e.g. ability to draw certain types of lines or brush strokes), drawing object instances or plans previously created or purchased, etc.

The user profile may also include a listing 906 of the various drawings that the user has created. This listing can be a simple file name listing, or it can include the full object profiles for the various objects that the user has created.

The user profile may also include one or more skill level identifiers 907. These identifiers may indicate the number of experience points the user has acquired. As noted above, these experience points can be earned by creating drawings, or by performing other tasks such as giving ratings, exploring other plots of land, etc.

In some embodiments, the user's skill levels may be divided into multiple categories. For example, categories can include drawing classifications (e.g., buildings, ground cover, etc.), and the user can have different levels of experience points with each classification. So a user might have 1000 points in building creation, but only 100 points in ground cover creation because he/she has spent more time drawing buildings than ground cover.

In some embodiments, the user profile can also include information identifying the popularity 908 of the user's creations. This can be, for example, an average rating of all the ratings received by the user's creations, or it can be a stored database containing all ratings and comments for those creations.

The user profile can also include association information 909, identifying associations and relationships that the player has with other players. For example, the association information 909 can include a list of player names for the players that are friends with the profiled player. Associations can also include followers. A given player may have other players and/or friends who have requested to follow the first player, and to receive messages regarding the first player's creations (e.g., when the first player creates a new object, a message may be sent to the followers announcing this fact). Similarly, the association information 909 can identify the other players that the profiled player is following.

Other variations may be made as well. For example, when an object is created, it can be surrounded by a bounding volume to approximate an area volume occupied by the object in the virtual world. The bounding volume can be one or more shapes (e.g. prisms, cubes, cylinders, etc.). In some embodiments, the image (or its bounding volume) can be sliced into multiple parts, with each part mapped to its own bounding volume. For example, a streetlight may be sliced into two parts, the pole and the arm that hangs over the street. Each part can be bounded by its own bounding cylinder and the boundary between the cylinders can be a slice point. Such slices and bounding volumes can be used to assist in establishing rendering order (depth sorting) and collision detection.

As noted above, an object plan parameter may include an identification of skill level requirements for crafting the object. To keep the game active, it may be desirable for a system or game administrator to help ensure that the level requirements are appropriately set. For example, an object that is difficult to create should be set at a higher level than an object that is not difficult to create. To assist with this, the computing device may be configured to review an object plan, and provide an estimate of an appropriate skill level requirement. The algorithm for such a plan review can examine the plan for certain characteristics, and increase (or decrease) the suggested skill level requirement based on those characteristics. For example, one characteristic may be the number of drawing strokes. The algorithm may indicate that drawings having fewer than 100 strokes should require a lower experience level, such as level 5 on a scale of 1-100. Drawings having over 1000 strokes may require a medium experience level, such as level 50, while drawings having over 10,000 strokes may require a very high level, such as level 100.

Other characteristics may be taken into account, and the overall recommend level can be an average of the individual characteristic recommendations. For example, a second characteristic may be based on the type of stroke. A straight line stroke may be considered easier than a curved stroke, so the computing device can weight these different stroke types differently when totaling the number of strokes. Alternatively, a separate scale can be used for stroke type, such that objects exceeding 500 or 50% in curved strokes may automatically receive a +10 to the recommended skill level.

The characteristics can also depend on the type of object, or the color. For example, objects having stone colors (e.g., grey) or classified as stone may require a higher stoneworking skill level. Objects having plant colors (e.g., green and brown) or classified as plants may require a higher plant skill level.

In some embodiments, compound objects that are an aggregated set of smaller instances of objects may be created. For example, a player may place 100 instanced objects in his/her plot to form a scene, such as multiple flowers placed in a garden. The player can designate those 100 objects (e.g., via group selection with a selection box) as being a compound object, and the computing device can create a compound object plan file identifying the object instances that are in the group, along with position information identifying where each object is located in the group (e.g., coordinates, orientation, etc.). The compound object plan may contain similar data as the object plan file discussed above, with information identifying the list of constituent objects and their relative placement within the compound objects (e.g., 100 instances of sunflowers, with positions at a, b, c, etc.). Other players may acquire the compound object plan similar to the acquisition of object plans, and those players can use the compound object plan to try to recreate the scene. In this recreation, the computing device can step through the listed objects, instructing the player on what object is needed next, and where it should go, to recreate the scene (or any other compound object whose plan is available to the player). The device may cause a flashing icon to appear at the location, with an identification of the object (or object type) that is needed. For example, a position in a castle wall may call for a stone cube, but the plan may allow for other types of cubes, and the player may be permitted to substitute different types of cubes (e.g., a wood class cube) at the indicated location.

Of course, as an alternative to recreating the scene step-by-step, the computing device may also offer the user the option at simply purchasing the entire scene or compound object. This may require a high amount of energy, resources and skill.

As noted above, a player may create or acquire an object plan, and may view it in a replay mode. If the player wishes to create an alternative version of the object plan, the player may be permitted to view the replay, stop the replay at a desired position (e.g., 100 strokes into it), and open up the drawing interface to being drawing (e.g., at the 101^{st} stroke). In this manner, the user may easily create modifications to objects. In some embodiments, this is only permitted if the player owns the object plan, while the object instances may be immutable (e.g., the user is prohibited from editing or copying an object instance, and instead is instructed to obtain the object plan to make edits or copies).

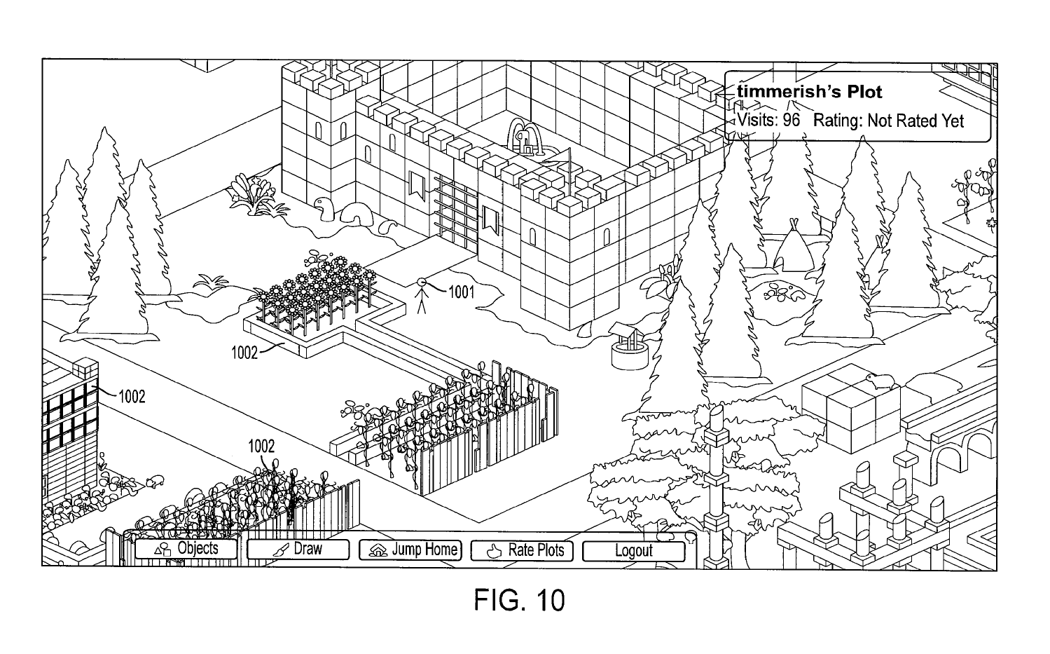

FIG. 10 illustrates an alternative example orthographic view of a display screen for a virtual world, similar to that of FIG. 2. As illustrated, a player's avatar 1001 may navigate around a variety of drawn objects 1002, and can interact with them to rate them. In the FIG. 10 example, objects on the plots of virtual land may all have been drawn by players of the game.

As noted above, players may buy and sell their drawn objects and/or object plans. In some embodiments, the asking prices for the objects can be set by the seller. In other embodiments, the prices may be automatically adjusted based on the ratings that the object receives. For example, a seller of an instance of a sunflower may ask 10 coins for purchasing the instance. If the sunflower (or the sunflower's object plan) receives over 1000 ratings of 4 stars or better, the computing device and/or application server 103 may automatically increase the asking price by a set percentage (e.g., 10%) to account for its highly rated value.

In the example above, the bounding volume 504 was described as being created by the artist who first drew the object. In some embodiments, the bounding volume 504 may be created by a different individual. For example, a second player can acquire the object plan, and in using it to create a new derivative object plan, the second player can create a new bounding volume. As another alternative, a system administrator may allow other players to submit revised bounding volumes for an existing instance of an object, in case an original artist was inaccurate in defining the original bounding volume. Additionally, although the player can adjust the dimensions of the bounding volume, the player can also make finer adjustments to the bounding volume. For example, the player can customize the bounding volume's 3 D outer contour to be a curve, spline shape, or any other desired surface shape to follow the contour of the drawing. In some embodiments, a 3D camera may be used to identify specific positions along the surface for customizing the bounding volume.

The various features described above are merely nonlimiting examples, and can be rearranged, combined, subdivided, omitted, and/or altered in any desired manner. For example, features of the servers can be subdivided among multiple processors and computing devices. The true scope of this patent should only be defined by the claims that follow.

We claim:

1. A game method, comprising:
providing, by a computing device, drawing tools to allow a player to draw a two-dimensional object using line strokes on a drawing interface;
displaying a bounding volume on the interface, the bounding volume having an orthographic appearance and being adjustable in three orthographic dimensions;
receiving user input to adjust one or more of the orthographic dimensions of the bounding volume to surround the drawn object and customize the bounding volume for the object, and assigning volume dimensions of the bounding volume to the two-dimensional object;
generating a display of the object in an orthographic graphical world image maintained by the computing device, and using the object's assigned bounding volume dimensions to detect collisions when placing the object in the orthographic graphical world image; and
providing the player with an in-game reward based on usage of the object by other players in the orthographic graphical world maintained by the computing device

2. The method of claim 1, further comprising:
storing an object file for each instance of a drawing object, and allowing players to buy and sell instances of the drawing object.

3. The method of claim 2, wherein a price of the drawing object is based in part on ratings that the object has received from other players.

4. The method of claim 1, further comprising:
providing an energy bar amount to the player; and
deducting energy from the energy bar as the player crafts an instance of an object from an object plan.

5. The method of claim 4, further comprising:
inhibiting crafting of new instances of objects by a player when the player's energy bar is depleted below a required amount for an object.

6. The method of claim 4, further comprising:
periodically replenishing the player's energy bar by a predetermined amount.

7. The method of claim 1, further comprising:
providing a limited amount of virtual ink resources to the player; and
deducting amounts of virtual ink from the player's ink resources as the player crafts instances of an object, wherein the amounts of virtual ink deducted is determined based on a number of strokes used by the object creator to draw the object.

8. The method of claim 7, further comprising:
replenishing the player's ink resources in response to the player positioning an onscreen avatar near an ink well in the graphical world and interacting with the well.

9. The method of claim 1, further comprising:
tracking experience points earned by the player as the player crafts objects;
using the experience points to restrict the player from attempting to craft objects that have a minimum experience point level above the player's experience point level.

10. The method of claim 9, further comprising tracking multiple classes of experience points for the player, each class of experience points corresponding to different classes of drawn objects.

11. The method of claim 1, further comprising receiving ratings of the object from a plurality of other users, and periodically awarding in-game currency to the player based on a rating level received by the player's drawing creations.

12. An online gaming method, comprising:
providing, by a computing device, a signal containing a video image having a navigable orthographic map having plots of land;
populating the plots of land with aggregate sets of player-drawn orthographic objects;
collecting player ratings for the sets of objects; and
using the ratings to generate rewards for the creators of the rated sets of objects.

13. The method of claim 12, comprising:
generating a drawing interface though which a player is allowed to draw an object using a plurality of line strokes;
storing an object plan file for the drawn object;
using the object plan file to craft instances of the object;
storing an object instance file for the crafted instance; and
displaying the instance at a location specified by the player, wherein the object plan file contains a data value indicating how well aggregate sets containing the object's instances have been rated by other players of the game.

14. The method of claim 12, further comprising:
maintaining a first limited resource level for a player;
permitting the player to draw an object without depleting the first resource; and
depleting the first resource when crafting an instance of the drawn object.

15. The method of claim 14, further comprising:
maintaining a second limited resource level for the player;
permitting the player to draw the object without depleting either the first resource or the second resource; and
depleting both the first and second resources when crafting the instance of the drawn object.

16. The method of claim 15, further comprising:
automatically replenishing the first resource according to a predetermined schedule; and
replenishing the second resource in response to the player navigating a player avatar to a predetermined resource supply object in the orthographic map.

17. The method of claim 12, further comprising:
defining a theme for a themed plot in the orthographic map;
increasing ratings on instance set of object instances placed in the themed plot if rating users indicate that the set fits the defined theme.

18. The method of claim 12, comprising:
generating a drawing interface though which a player is allowed to draw a two-dimensional image using a plurality of line strokes;
displaying a resizable bounding volume on the interface, and receiving player input to size the bounding volume to surround the drawn image; and
using the bounding volume dimensions to position the two-dimensional image using three dimensions in the orthographic map.

19. The method of claim 12, wherein the reward for the player includes replenishing a limited resource of the player, wherein the limited resource is used in creating instances of drawn objects.

20. An online game method, comprising:
generating, by a computing device, a video signal having an orthographic map having a plurality of area plots, and a plurality of player avatars moving among the plots;
allowing, by the computing device, players to draw two-dimensional images using a plurality of line strokes, and to convert the two-dimensional images into orthographic images having volume;
placing the converted orthographic images into the orthographic map in response to a first player's crafting request;
reducing a limited resource of the first player in response to the placing and crafting;
regenerating the limited resource according to a predetermined time schedule;
receiving player ratings of the placed drawn object; and
rewarding the first player with in-game resources based on ratings of the first player's drawn object.

21. The method of claim 1, wherein the defining a custom bounding volume to match the drawing includes adjusting an outer contour of the bounding volume to follow an outer contour of the object.

22. An online game method, comprising:
providing, by a computing device, a video image of an orthographic graphical environment, wherein the orthographic graphical environment includes a plurality of object instances;
receiving a player request to define a group of the objects as a compound object;
generating a compound object plan for the defined group, wherein the compound object plan includes information identifying constituent objects and their positions in the group; and
granting the player an in-game reward based on how ratings of the compound object as provided by a plurality of other players in the game.

23. The method of claim 22, wherein the compound object plan further includes a history, identifying a sequence of object placement used by the player to position the objects in the orthographic graphical environment.

24. The method of claim 23, further comprising:
receiving a request from a second player to generate an instance of the compound object by viewing a replay of the compound object plan history.
